(19) United States
(12) Patent Application Publication
(10) Pub. No.: US 2020/0242835 A1
(43) Pub. Date: Jul. 30, 2020

(54) SYSTEM AND METHOD FOR GENERATING AUGMENTED REALITY 3D MODEL

(71) Applicant: Nick Cherukuri, Princeton, NJ (US)

(72) Inventor: Nick Cherukuri, Princeton, NJ (US)

(73) Assignee: ThirdEye Gen, Inc., Princeton, NJ (US)

(21) Appl. No.: 16/261,736

(22) Filed: Jan. 30, 2019

(51) Int. Cl. G06T 17/20; G06T 19/00; G06T 7/579; G06T 7/70

(52) U.S. Cl. CPC G06T 17/20; G06T 19/006; G06T 2207/10028; G06T 7/70; G06T 2200/08; G06T 7/579

(57) ABSTRACT

A system and method to create an augmented reality 3D model in an editable format using a video feed from an augmented reality device, is disclosed. The augmented reality device comprises one or more image capturing device to capture the video feed data, and a processing component. The processing component is configured to process the video feed data and produce a scan data comprising a sparse point cloud, wherein the scan data comprises a list of keyframes, and wherein each keyframes comprises an image. The system further comprises one or more computing devices in communication with the augmented reality device via a network. The computing device is configured to create a dense point cloud utilizing the scan data, and convert the dense point cloud into an editable 3D model.

### BACKGROUND OF THE INVENTION

### A. Technical Field

The present invention generally relates to augmented reality, and more specifically relates to a system and method for generating augmented reality 3D model utilizing a camera feed of an augmented reality (AR) device.

### B. Description of Related Art

Augmented reality environment combines virtual reality with the real world in the form of live video imagery that is digitally enhanced with computer-generated graphics. Augmented reality environments allow users, real-world objects and virtual or computer-generated objects and information to interact with one another. Such an experience greatly enhances the user's experience and enjoyability with the augmented reality system, and also opens the door for a variety of applications that allow the user to experience real objects and virtual objects simultaneously. Augmented reality (AR) systems may be useful for many applications, spanning the fields of scientific visualization, medicine and military training, engineering design and prototyping, tele-manipulation and tele-presence, and personal entertainment.

However, there are significant challenges in providing such a system. To provide a realistic augmented reality experience to users, AR system need to focus on the end-user's physical surrounding, spatial space, and accessibility to correctly match a location of virtual objects in relation to real objects. The AR system has to follow changes in real-world and properly adapt virtual objects to match those changes. Further, the AR system must correctly know how to position virtual objects in relation to the user. This requires extensive knowledge of the user's position in relation to the world at all times. Few existing prior arts developed to address the aforesaid issues are disclosed as follows.

A prior art, U.S. Pat. No. 9,766,703 B2 assigned to Miller Samuel A., describes an augmented reality system with image capturing devices, configured to capture a set of 2D points of a real-world environment and sends to a remote computing system to determine respective positions of the image capturing devices for the set of 2D points. Three-dimensional (3D) position of 2D point are determined from the set of 2D points and the respective positions and a virtual content for the real-world environment is generated at the augmented reality system using at least the three-dimensional position that is shared via a computer network.

Another prior art, U.S. Pat. No. 8,928,729 B2 assigned to Schnyder Lars, describes a method of converting a 2D video data to 3D video data. The system receives a two-dimensional (2D) video feed which includes a set of image frames (panorama image) from a video camera and transmit to a remote device for converting the 2D video to a 3D video data. The converted 3D image is again sent back to the device for display.

The above disclosed approach lack to provide a full 3D model and hence, lacks in user satisfaction. Therefore, there is a need for an augmented reality 3D model generation utilizing a camera feed of an augmented reality device.

### SUMMARY OF THE INVENTION

The present invention provides a system and method to create an augmented reality (AR) 3D model in an editable format utilizing a camera feed of an augmented reality device. The system is configured to convert a video feed data of a filmed 3D object into a 3D model (also referred as scanning process). The produced 3D model could be overlaid on its real-life counterpart using the augmented reality device (also referred as overlaying process).

According to the present invention, the system comprises an augmented reality device and one or more computing device in communication with the augmented reality device. The augmented reality device comprises a processing component, one or more image capturing devices and a display surface. The computing device comprises a processing unit and a memory unit. The processing component comprises a scan component configured to process the video feed data and produce a scan data comprising a sparse point cloud, wherein the scan data further comprises a list of keyframes, and wherein each keyframes comprises an image. The computing device in communication with the augmented reality device is configured to create a dense point cloud utilizing the scan data, and convert the dense point cloud into an editable 3D model.

The processing component further comprises a local feature detector component configured to analyze each frame of the video feed to extract a local feature descriptor. the scan component comprises one or more sub-component comprising: a pose tracking component, a point cloud building component, and a loop closing component. The pose tracking component is configured to determine an orientation information of the augmented reality device in a 3D space with respect to each frame of the video feed data and determine if each frame need to be added to the sparse point cloud and list of keyframes based on the orientation information. The point cloud building component is configured to configured to extract and add a triangulated 3D points of each frame to the sparse point cloud, based on the decision of the pose tracking component. The loop closing component is configured to detect overlap of keyframes. In one embodiment, the sparse point cloud is constructed from a local feature descriptor utilizing a simultaneous localization and mapping (SLAM) algorithm. The processing component further comprises an overlay component configured to display the generated 3D model utilizing the augmented reality device.

In an embodiment, an augmented reality 3D model generation method is disclosed. The method includes a step of: capturing a video feed data comprising one or more keyframes at an augmented reality device comprising one or more image capturing device and a processing component. The method further includes a step of: processing the captured video feed data at the processing component of the augmented reality device. The method further includes a step of: generating a scan data comprising a sparse point cloud for the captured video feed data, wherein the scan data further comprises a list of keyframes, wherein each frame comprises an image. The method further includes a step of: computing a dense point cloud at a computing device in communication with an augmented reality device utilizing the scan data. The method further includes a step of: converting the dense point cloud into a 3D mesh utilizing a concave hull algorithm. The method further includes a step of: storing the generated 3D mesh in editable format.

Further, the step of processing includes: analyzing each frame of the video feed to extract a local feature descriptor, and constructing the sparse point cloud from a local feature descriptor utilizing a simultaneous localization and mapping (SLAM) algorithm. Further, the sparse point cloud construction steps comprises: determining the orientation information of the augmented reality device in a 3D space with respect to each frame of the video feed data and determine if each frame need to be added to the sparse point cloud and list of keyframes based on the orientation information; extracting and adding a triangulated 3D points of each frame to the sparse point cloud, via a point cloud building component, based on the decision of the pose tracking component, and detecting overlap of keyframes via a loop closing component.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 exemplarily illustrates a system for generating augmented reality 3D model in an embodiment of the present invention.

FIG. 2 exemplarily illustrates a scanning process in an embodiment of the present invention.

FIG. 3 exemplarily illustrates various components and their connections of the augmented reality 3D model generation system in an embodiment of the present invention.

FIG. 4 exemplarily illustrates an overview of building a sparse point cloud in an embodiment of the present invention.

FIG. 5 exemplarily illustrates a flowchart of an augmented reality 3D model generation method in an embodiment of the present invention

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The present invention provides a system and method to create an augmented reality 3D model in an editable format using an augmented reality device. The system is configured to convert a video feed data with a filmed 3D object into a 3D model (also referred as scanning process). The produced 3D model could be overlaid on its real-life counterpart using the augmented reality device (also referred as overlaying process).

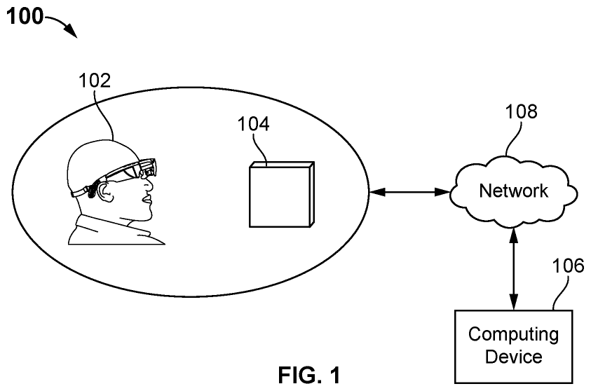

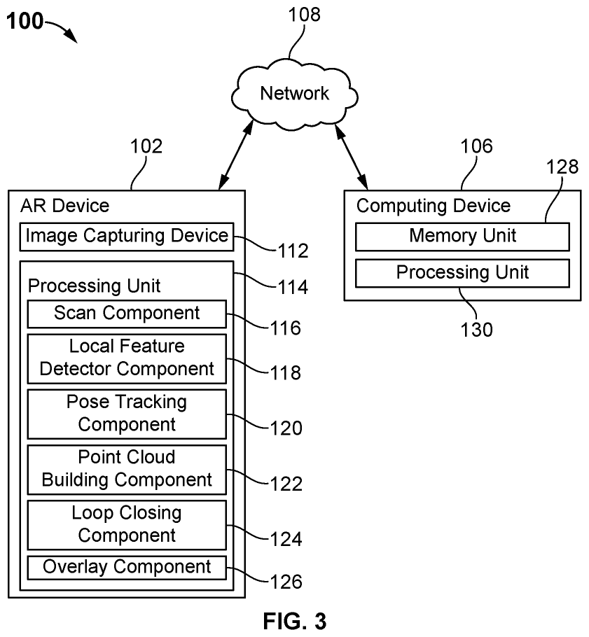

Referring to FIG. 1, the system 100 comprises an augmented reality device 102 and one or more computing device 106 in communication with the augmented reality device 102. The augmented reality device 102 comprises one or more image capturing devices 112 and a display surface. The display surface comprises a display lens capable of displaying augmented reality (AR) content, enabling the wearer to view both the display surface and their surroundings. Referring to FIG. 3, the computing device 106 comprises a processing unit 130 and a memory unit 128. In one embodiment, the computing device 106 is a server. In one embodiment, the network 108 could be at least one of a wired or wireless network. The augmented reality device 102 is configured to capture the video feed from the device's 102 camera that would be processed into a 3D model in the scanning process, and display the holographic overlay of a real-life object (that was previously scanned) using the device's 102 see through display.

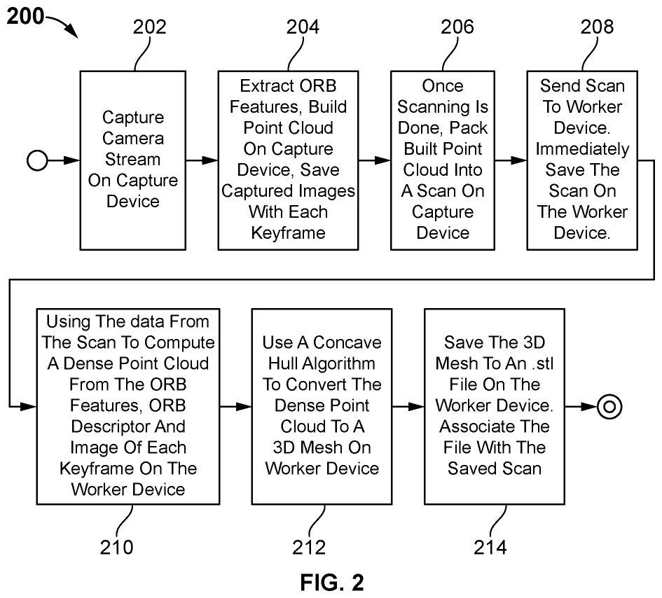

FIG. 2 illustrating a scanning process 200 in an embodiment of the present invention. At step 202, the augmented reality device 102 is configured to capture the video feed data of a 3D object utilizing the image capturing device 112. The device 102 comprises one or more processing unit or component 114 (shown in FIG. 3), which is configured to analyze the video feed data to extract ORB features and construct a sparse point cloud, at step 204. In one embodiment, the processing component 114 comprises an application or set instruction to execute the functionality of the augmented reality device 102. At step 206, the augmented reality device 102 is configured to analyze the video feed data and outputs a scan data. At step 208, the output scan data is sent to the computing device 106.

In one embodiment, the scan data comprises a sparse point cloud data, list of keyframes comprising capture images, ORB features and ORB descriptor. The computing device 106 is configured to save the scan data for further computation process. At step 210, the computing device 106 is configured to compute a dense point cloud utilizing the scan data. At step 212, the computing device 106 is further configured to convert the dense point cloud to a 3D mesh. At step 214, the generated 3D mesh is saved to an .stl file in the computing device 106. During the overlaying process, a selected 3D model along with its metadata would be transferred back to the augmented reality device 102 for presentation on the optical see-through display.

Referring to FIG. 3, the processing component 114 comprises a scan component 116 and a local feature detector component 118. The processing component 114 is configured to capture video feed data comprising one or more frames utilizing the image capture device 112. The local feature detector component 118 is configured to analyze each frame of the video feed data to extract the characteristic features of the image. The scan component 116 is configured to construct a sparse point cloud (also referred as a scan data) from the extracted characteristic features of the video feed data. In one embodiment, the scan component 116 utilizes a simultaneous localization and mapping (SLAM) algorithm to construct the sparse point cloud. The scan data enables to track the position and orientation of the augmented reality device 102 capturing the video feed data in 3D space. The constructed sparse point cloud provides a keyframe data comprising a list of keyframes. In another embodiment, the keyframe data further comprises relevant metadata of the list of keyframes.

In an embodiment, the scan component 116 further comprises one or more sub-components including a pose tracking component 120, a point cloud building component 122 and a loop closing component 124. The pose tracking component 120 is configured to determine the orientation information of the augmented reality device 102 in a 3D space with respect to each frame of the video feed data and determine if each frame need to be added to the sparse point cloud and list of keyframes based on the orientation information. In one embodiment, operation of the pose tracking component 120 is described as follows. For each captured frame, the pose tracking component 120 uses the information from a previous tracked frame, as well as a subset of the sparse point cloud to estimate the pose of the device in the current frame. Once the pose estimate has been computed, it is optimized relative to previously registered fames (keyframes) that share some of the ORB feature of the current frame, which yields an accurate pose estimate. Then, the pose tracking component 120 is configured to determine if a new keyframe need to be inserted into the set of keyframes. In case an initial pose estimate cannot be obtained, the system 100 is presumed to be “lost”. The pose tracking component 120 uses the ORB descriptor extracted from the current frame to find a previously inserted keyframe with a similar descriptor and sufficiently matching features, so that it can re-localize the device 102 in the sparse point cloud and resume tracking. The output of the pose tracking component 120 is the current pose of the device in 3D space, as well as a decision whether the sparse point cloud and set of keyframes should be expanded by the currently processed frame.

The point cloud building component 122 is configured to configured to extract and add a triangulated 3D points of each frame to the sparse point cloud, based on the decision of the pose tracking component 120. The point cloud building component 122 is configured to expanding the sparse point cloud and set of keyframes with new entries. The point cloud building component 122 is configured to add keyframes, if the pose tracking component 120 provides a decision that the currently processed frame should be turned into a new keyframe of the system 100. The point building cloud component 122 further proceeds to extract 3D points triangulated out of the keyframes ORB features, and add them to the sparse point cloud. Additionally, the point cloud building component 122 also configured to execute tasks, including detecting and removing invalid cloud points, detecting and removing invalid keyframes, and optimizing the point cloud with local bundle adjustment. Each new keyframe is also inserted into the loop closing subsystem/component 124, so that it can be tested for loops.

The loop closing component 124 is configured to detect overlap of keyframes. A loop is described as a situation where the system 100 detects that the device has returned to a previously occupied position and orientation, after being successfully tracked in significantly other positions and orientations. For each passed keyframe, the loop closing component 124 configured to detect whether the current keyframe overlaps with one of the previously added keyframes. If such a situation occurs, the loop is closed by merging the current keyframe with the other found keyframe. Additionally, since the two merged keyframes share the same position and orientation, the offset between their estimated poses is equal to computational error that was accumulated in the algorithm for the duration of the loop. Therefore, after each loop is closed the entire point cloud is error corrected by means of global bundle adjustment.

The produced sparse point cloud enables to determine the frame of reference for the scanned model in world space, and establish a relation between features of the scanned model and other features of the environment. This set of relations is used by the overlay component 126 to re-embed the scanned model in the same environment during the overlaying process. The sparse point cloud further provides the list of “keyframes”, i.e. frames of the captured video feed that differ significantly from the previously registered frames, and thus most probably represent a different point of view on the scanned model. Each keyframe stores the captured image, as well as other metadata necessary to later produce a dense point cloud on the computing device 106. During construction of the sparse point cloud new points are successively added for each observation of a given point of view. Once the number of new points added to the cloud with each consecutive observation of the same point of view drops below a give threshold, the device 102 alerts the user via the UI regarding sufficient scan of the current point of view. Further, the user may move on to other points of view.

On capturing all of the desired points of view, the device 102 wrap the sparse point cloud, along with the list of keyframes, and any other relevant metadata and send into a single data package (referred as scan data). The augmented reality device 102 establishes a connection to the computing device 106 over a local network, and send the scan data to the computing device 106 for further processing. The computing device 106 stores the scan data and use the images form the list of keyframes, along with their metadata (such as a keyframes position and orientation in 3D space, and the list of extracted characteristic features) constructed along with the sparse point cloud to build a dense point cloud. The computing device 106 converts the dense point cloud into convert it into a 3D model, consisting of a mesh of triangles. The triangles constituting the 3D model are triangulated from a concave hull computed on the dense point cloud. The computing device 106 saves the 3D model as an .stl file. The computing device 106 also associate the previously saved scan, along with all its data to the produced 3D model for future reference in the overlaying process.

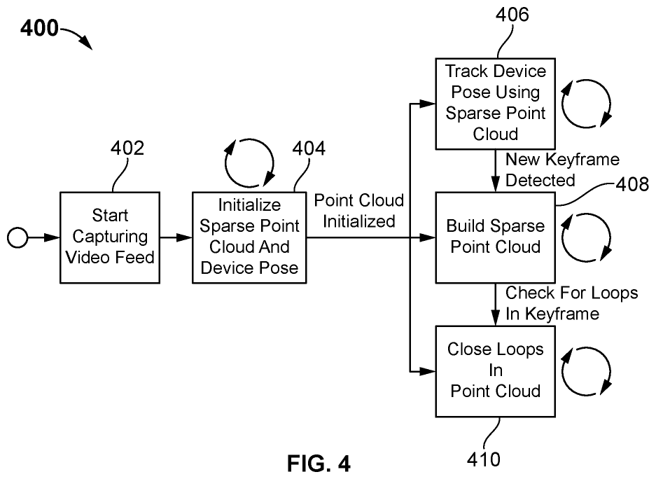

FIG. 4 discloses an overview of building the sparse point cloud 400, in an embodiment of the present invention. At step 402, the device 102 starts to capture a video feed. At step 404, the device 102 initializes point cloud construction. On initialization of construction, the processing component 114 is configured to track device pose using sparse point cloud 406, add points to sparse point cloud on detection of new keyframe 408 and checks for loops in keyframe 410. The sparse point cloud for the video stream captured from a single monocular camera is a crucial feature of the system 100, for both the scanning process and overlaying process. The generated point cloud serves as a base for later generating a dense point cloud in the computing device 106, form which a scanned model can be computed. It also serves as a frame of reference that embeds the scanned model in the environment of the source real-life object, and thus enables displaying it with the proper pose (i.e. position and orientation) during the overlaying process by the overlay component 126.

In one embodiment, generation of the sparse point cloud is conducted using an algorithm from the family of simultaneous localization and mapping (SLAM) algorithms. A real time variant of these algorithms (such as the one used in the system) typically analyzes the video from one or several cameras, and computes the characteristic features and feature descriptor of each frame using a local feature detector component 118. In one embodiment, the local feature detector component 118 is an Oriented FAST, Rotated BRIEF (ORB) feature detector. Due to sufficient performance for real time applications, high invariance to rotations, sufficient invariance to scaling, and the fact that this feature detector produces a unique feature descriptor ORB currently stands out as the best solution for such applications. Once the ORB descriptor has been extracted along with a set of 2D positions of the characteristic features, the algorithm needs to triangulate these features into 3D points that will make up the point cloud. While this operation is trivial in case depth information in readily available (e.g. with a stereo, or RGB-D camera), our case is significantly more complicated, as the device 102 only supports one RBG camera, a setup commonly referred to as “Monocular”.

To triangulate points in 3D space out of the extracted 2D ORB features, a depth form motion algorithm is used, where the ORB features of each frame are compared with those of an established reference frame. The depth information is then computed using a homography matrix, or fundamental matrix calculated on the corresponding features in both images. Correctly initializing the point cloud with 3D positions of points will also yield an initial position and orientation of the device.

Once the point cloud has been correctly initialized with a sufficient number of initial 3D points, and an initial pose (position and orientation) of the device 102 has been established, the algorithm will proceed to track the pose of the capture device 102 relative to the point cloud. At the same time, the device 102 expands the point cloud by triangulating 3D points out of features in consecutive frames, and expands the list of keyframes with each estimated pose that is sufficiently different from others.

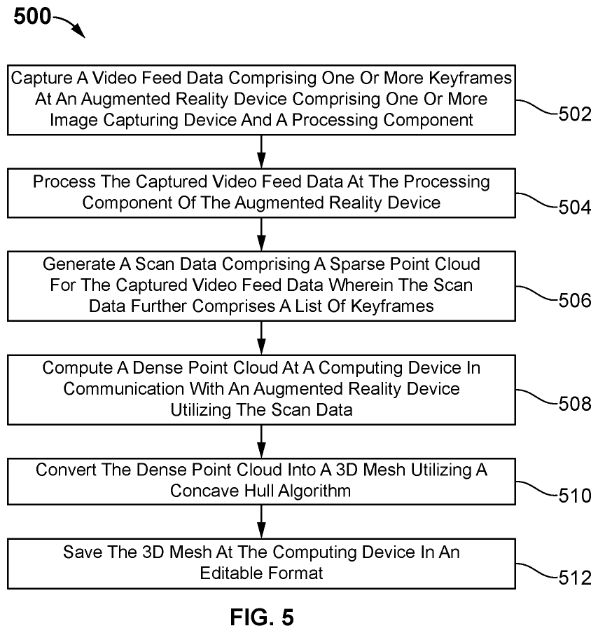

FIG. 5 exemplarily illustrates a flowchart 500 of an augmented reality 3d model generation method in an embodiment of the present invention. The method includes a step 502 of: capturing a video feed data comprising one or more keyframes at an augmented reality device 102 comprising one or more image capturing device 112 and a processing component 114. The method includes a step 504 of: processing the captured video feed data at the processing component 144 of the augmented reality device 102. The method includes a step 506 of: generating a scan data comprising a sparse point cloud for the captured video feed data, wherein the scan data further comprises a list of keyframes, wherein each frame comprises an image. The method includes a step 508 of: computing a dense point cloud at a computing device 106 in communication with an augmented reality device 102 utilizing the scan data. The method includes a step 510 of: converting the dense point cloud into a 3D mesh utilizing a concave hull algorithm. The method includes a step 512 of: storing the generated 3D mesh in editable format.

Further, the step of processing further includes: analyzing each frame of the video feed to extract a local feature descriptor, and constructing the sparse point cloud from a local feature descriptor utilizing a simultaneous localization and mapping (SLAM) algorithm. The sparse point cloud construction steps comprises: determining the orientation information of the augmented reality device 102 in a 3D space with respect to each frame of the video feed data and determine if each frame need to be added to the sparse point cloud and list of keyframes based on the orientation information, at a pose tracking component 120 of the augmented reality device 102; extracting and adding a triangulated 3D points of each frame to the sparse point cloud, via a point cloud building 122 component, based on the decision of the pose tracking component 120, and detecting overlap of keyframes via a loop closing component 124.

The scanning process and the overlaying process comprises heavy computation, which is impractical to perform on a wearable augmented reality device. Also, performing heavy computation on an augmented reality device impedes the ability of the device to provide real time interaction with the user, as well as significantly diminish the battery life of the device. Hence, the present invention incorporates the scanning process and the overlaying process in separate computing devices connected via a network. The present invention creates an augmented reality 3D model in an editable format using the augmented reality device 102. The .stl format of the produced model would make it readily available for processing by CAD software, as well as other 3D modelling software. The model could also be edited using a third-party software. As the produced sparse point cloud is saved independently of the model, it will continue to serve its purpose for the overlaying process regardless of modifications, as long as it's frame of reference is maintained. Thus, the user may replace the scanned model on the computing device 106 with a modified one at will. The user may also transfer a scanned model along with its associated scan data to another computing device 106.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for generating augmented reality 3D model, comprising:
an augmented reality device comprising one or more image capturing device to capture a video feed data comprising one or more frames, and a processing component,
wherein the processing component comprises a scan component configured to process the video feed data and produce a scan data comprising a sparse point cloud,
wherein the scan data further comprises a list of keyframes, and
wherein each keyframes comprises an image, and
one or more computing device in communication with the augmented reality device configured to create a dense point cloud utilizing the scan data, and convert the dense point cloud into an editable 3D model.

2. The system of claim 1, wherein the processing component further comprises a local feature detector component configured to analyze each frame of the video feed to extract a local feature descriptor.

3. The system of claim 1, wherein the sparse point cloud is constructed from a local feature descriptor utilizing a simultaneous localization and mapping (SLAM) algorithm.

4. The system of claim 1, wherein the scan component comprises one or more sub-component comprising:
a pose tracking component configured to determine an orientation information of the augmented reality device in a 3D space with respect to each frame of the video feed data and determine if each frame need to be added to the sparse point cloud and list of keyframes based on the orientation information;
a point cloud building component configured to configured to extract and add a triangulated 3D points of each frame to the sparse point cloud, based on the decision of the pose tracking component, and
a loop closing component configured to detect overlap of keyframes.

5. The system of claim 1, wherein the processing component further comprises an overlay component configured to display the generated 3D model utilizing the augmented reality device.

6. The system of claim 1, wherein the capturing device is a single monocular camera.

7. The system of claim 1, wherein the augmented reality device is a wearable device comprising a display lens capable of displaying augmented reality (AR) content.

8. The system of claim 1, wherein the augmented reality device is in communication with the computing device via at least one of a wired or wireless network.

9. The system of claim 1, wherein the scan data further comprises ORB features and ORB descriptor.

10. The system of claim 1, wherein the computing configured to store the 3D model in .stl format.

11. The system of claim 1, wherein the 3D is editable in CAD format.

12. A method for generating augmented reality 3D model, comprising the steps of:
capturing a video feed data comprising one or more keyframes at an augmented reality device comprising one or more image capturing device and a processing component;
processing the captured video feed data at the processing component of the augmented reality device;
generating a scan data comprising a sparse point cloud for the captured video feed data, wherein the scan data further comprises a list of keyframes, wherein each frame comprises an image;
computing a dense point cloud at a computing device in communication with an augmented reality device utilizing the scan data, and
converting the dense point cloud into a 3D mesh utilizing a concave hull algorithm.

13. The method of claim 12, wherein the step of processing further includes:
analyzing each frame of the video feed to extract a local feature descriptor, and constructing the sparse point cloud from a local feature descriptor utilizing a simultaneous localization and mapping (SLAM) algorithm.

14. The method of claim 12, wherein the sparse point cloud construction steps comprises:
determining the orientation information of the augmented reality device in a 3D space with respect to each frame of the video feed data and determine if each frame need to be added to the sparse point cloud and list of keyframes based on the orientation information, at a pose tracking component of the augmented reality device;
extracting and adding a triangulated 3D points of each frame to the sparse point cloud, via a point cloud building component, based on the decision of the pose tracking component, and
detecting overlap of keyframes via a loop closing component.

15. The method of claim 12, further comprising the step of: storing the generated 3D mesh in editable format.
